(19) United States
(12) Patent Application Publication
(10) Pub. No.: US 2026/0310437 A1
(43) Pub. Date: Oct. 8, 2026

(54) DISTRIBUTED SOFTWARE NETWORK

(71) Applicant: David BOXENHORN, Jerusalem (IL)

(72) Inventor: David BOXENHORN, Jerusalem (IL)

(21) Appl. No.: 19/476,748

(22) PCT Filed: Apr. 17, 2024
(86) PCT No.: PCT/IL2024/050377

§ 371 Date: Oct. 20, 2025

Related U.S. Application Data
(60) Provisional application No. 63/460,112, filed on Apr. 18, 2023.

(51) Int. Cl. G06F 8/61

(52) U.S. Cl. CPC G06F 8/61

(57) ABSTRACT

A networked computing system for facilitating distributed software and allowing independent access by a remote entity to the software via data, has remote terminal devices, corresponding user identities and a corresponding user, applications for manipulating data, each application having an application identity, hosts for storing data and applications, wherein the data is stored in software objects associated with respective applications and hosted at hosts who each have a unique host identity. The hosted software objects each have enablement data, a host identity of the associated host, a user identity of a user associated with the object, the application identity of the relevant application, and a unique object identity.

### RELATED APPLICATION/S

This application claims the benefit of priority of U.S. Provisional Patent Application No. 63/460,112 filed on Apr. 18, 2023, the contents of which are incorporated herein by reference in their entirety.

### FIELD AND BACKGROUND OF THE INVENTION

The present invention, in some embodiments thereof, relates to a distributed software network and, more particularly, but not exclusively, to a method of organizing software on a network to provide distributed control or ownership.

The original vision of the internet was for a completely decentralized network, but the reality today is that the internet is highly centralized around a small number of large web sites. The tendency for the internet to centralize around a few web sites was unanticipated, but in retrospect is an inevitable result of people using web sites instead of software. Just as there were once a small number of very popular software applications, there are now a small number of very popular web sites. The difference is that when there were a small number of very popular software applications, you still owned your copy of the application, and had complete ownership and control of your data. This phenomenon is sometimes called the “death of software.” We no longer own software, running on our own equipment, and creating data that belongs to us, but instead consume software directly from remote web sites. The software is owned by the provider, runs on the provider's web site, and the provider has full control over the data that we create, often owning it outright.

Networked computing using objects, U.S. Pat. No. 7,752,335 B2 Boxenhorn filed Dec. 3, 2003, discloses a system for networked computing using objects, each object comprising: enablement data, a first identity arrangement for holding a first identity indicating a host or provider of the object, and a second identity arrangement for holding a second identity of a remote entity establishing a relationship with the object via a network. Such a system supports network based computing and interactions between remote objects, including desktop-like behavior in which such remote objects are represented by desktop-like icons on a user terminal device.

### SUMMARY OF THE INVENTION

The present embodiments may provide that installations of applications and the corresponding data on a network may belong to and be under control of an end-user owner irrespective of how the application and data are actually distributed on the network. Thus the end-user who is using cloud computing for example, does not need to trust an unknown host regarding his data. Accordingly, the user does not need to trust the specific host that supplied the application, but rather is free to choose the best host in the opinion of the end-user

According to an aspect of some embodiments of the present invention there is provided a networked computing system for facilitating distributed software and allowing independent access by a remote entity to the software via data, the system comprising:
a plurality of remote terminal devices, each remote terminal device being associated with at least one user identity and a corresponding user;
a plurality of applications for manipulating data, each application being associated with an application identity;
a plurality of hosts, the plurality of hosts operative for storing data, the data for remote access and manipulation, the data being stored in software objects associated with respective applications, the software objects being hosted on hosts, the hosts each having a unique host identity, the hosted software objects respectively comprising:
   enablement data,
   a host identity of a host associated with the object,
   a user identity of a user associated with the object,
   an application identity of an application associated with the object, and
   a unique object identity.

In embodiments, the host and the application and the user identity arrangements, being contained within the hosted software objects and comprising the respective unique identities, enable a plurality of entities at respective remote terminals to access the enablement data, the respective host and application and user identity arrangements being preserved with the access such that manipulations of the software object by any one of the remote entities is independent of manipulation of the remote object by any other remote entity.

In embodiments, each respective host identity arrangement is transferable with correspondingly independently manipulated data to another one of the hosting servers for a second manipulation with the software object, the second manipulation preserving the host identity, application identity, and user identity, thereby allowing the respective remote entity to retain a relationship with the software object after manipulation thereof through the first software object.

In embodiments, the application identity arrangement, being contained within the software object, enables the object to find the application for manipulation irrespective of where the object and the application for manipulation thereof are hosted.

In embodiments, the hosting servers are configured to be subdivided based on one member of the group consisting of application and respective user identities.

In embodiments, the host identity, the application identity, the user identity and the object identity are combined to provide a unique object identification, the unique object identification being usable for communication with other objects.

Embodiments may include a database for storage of respective objects, the database configured to store corresponding data for each object.

In embodiments, the corresponding data comprises any of attributes, links and class identities for each object.

In embodiments, the database is a networked database storing at least one member of the group consisting of a respective host identity, a respective application identity and a respective user identity for a plurality of the objects.

Embodiments may comprise a server, the server configured to pass a message to an object based on an ID of the object contained in the message.

In embodiments, the server is configured to receive a message for an object and only to pass on the message to the respective object if the server is able to authenticate the message.

In embodiments, the authenticating is to verify both the sending object and the remote user.

In embodiments, the authenticating uses a certifying authority of a sending application and uses the sending application to verify the remote user.

In embodiments, the host identification comprises at least two segments, one of the at least two segments being allocated centrally over the networked computer system and being networkwise unique.

Embodiments may comprise network servers that provide hosts for the objects. The networked servers may support selected ones of the applications.

Embodiments may comprise a home application and home hosts implemented by the home application, each user having at least one home host, the home host comprising centralized information for the respective user.

Embodiments may comprise an application directory for registering and distributing applications, the application directory being configured to install requested applications in a home application accessible via a respective user's home host.

In embodiments, applications and hosts are installable per user so that a user is able to recognize an object created by an application or host installed by the user and reject an object created by an identical application or host not installed by the user.

According to a further aspect of the present invention, a hosted software object may include:
enablement data:
a host identity arrangement holding a respective unique host identity indicating one of the plurality of hosting servers or a provider of the object;
a user identity arrangement holding a respective user identity,
an application identity arrangement holding a respective application identity; and
an object identity arrangement holding a unique object identity.

In embodiments, the host identity, the application identity, the user identity and the object identity are combined to provide a unique object identification, the unique object identification being usable for communication with other objects.

A further aspect of the present invention may relate to a network server, configured to host the hosted software object.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified diagram of a network with distributed applications and owned objects according to a first embodiment of the present invention;

FIG. 2 is a simplified diagram illustrating messaging between objects on different hosts according to embodiments of the present invention;

FIG. 3 is a simplified diagram illustrating the operations that take place when a server gets a message for an object according to embodiments of the present invention, in which the object data is retrieved from the database; the implementation code for the object is retrieved; the object is created and sent the message;

FIG. 4 is a simplified diagram illustrating a provider architecture according to embodiments of the present invention and showing that providers have a database for each host and object implementations for each application;

FIG. 5 is a schematic view of an identification system according to the present embodiments;

FIG. 6 is a schematic illustration of an application distributed over many hosts in the network and a certificate authority, according to embodiments of the present invention;

FIG. 7 is a simplified diagram illustrating the use of a home application, an application directory, home hosts and application installation according to embodiments of the present invention; and

FIG. 8 is a simplified diagram of a hosted object according to embodiments of the present invention.

### DESCRIPTION OF SPECIFIC EMBODIMENTS OF THE INVENTION

The present invention, in some embodiments thereof, relates to a distributed software network and, more particularly, but not exclusively, to a method of organizing software on a network to provide distributed control or ownership.

The present embodiments may provide a networked computing system for facilitating distributed software and allowing independent access by a remote entity to the software and its data, so that you have your own copy on your own chosen location, has remote terminal devices, corresponding user identities and a corresponding user, applications for manipulating data, each application having an application identity, hosts for storing data, wherein the data is stored in software objects associated with respective applications and hosted at hosts who each have a unique host identity. The hosted software objects each have enablement data, a host identity of the associated host, a user identity of a user associated with the object, the application identity of the relevant application, and a unique object identity.

In the present embodiments, material on a network is arranged as objects. Every object belongs to four different entities, a user, a host, a physical location, and an application, and having the object identifying the application allows for an application-centered architecture. In U.S. Pat. No. 7,752,335 B2 Boxenhorn filed Dec. 3, 2003, and referred to above, the host was the center and the architecture did not address applications. By contrast the present disclosure teaches the application or the host or the user, or their combinations, as the center. The application controls the creation and implementation of hosts and objects, and thus the application may be placed anywhere but is used via objects that include the identity of the user. Installing the application accordingly provides the user with the ability to create objects that belong to that application as well as to the user. The objects may interact with the objects of other hosts, applications, and users. The object has a user ID and an application ID so that it is clear both who is the owner of each object, and to which application the object belongs. Physical existence of the application is now disconnected from the location of its objects. An application may be placed on any provider, and the user installs it, but the installation simply represents the ability of the user to create and own objects using that application, and to access the application.

Today, a user's data is either on one's own computer or out on the web. If out on the web it may or may not be available to others, but one must trust the web site of the application with the data. According to the present embodiments, the user may install the application on any provider and remains the owner of the data wherever the data is located and has control over access. The present embodiments may thus provide owning of data on the cloud. Today an application and its web site come together, and the level of security provided by the web site is the only security option, the user does not have an option to provide better security, or even to know how secure the data really is. The embodiments may also provide for convenient transfer of data between providers. The purpose of the distributed software network is to create a new framework to enable the “rebirth of software”—this time for a network such as the internet. The distributed software network enables people to own their software and data, and locate them where they want, on the network. It gives users all the advantages of a network such as the internet, without giving up ownership of applications or data. In addition, it enables the coordination and composition of applications on the internet, which makes it possible for applications to be combined in new ways, not yet seen.

The distributed software network described here builds off the existing browser-server architecture of the World Wide Web, but it is also possible to build it on top of some other network of servers running software. For example, it is very conceivable that future versions of the distributed software network will be built directly on the internet, bypassing the World Wide Web altogether. When built on top of the World Wide Web, the servers are web servers and the user-interface device is the browser. The distributed software network fixes critical flaws that currently prevent a distributed-software model of the internet. One critical flaw of the internet is that there is no notion of ownership in the network architecture. The internet behaves as if all applications and data on a server belong to that server. In reality, most of the data on internet servers today belongs to third parties, and most software belongs to the web site it runs on. With the distributed software network, data and software can be distributed to 3rd-party web sites, and the system will keep track of their ownership.

Features of the distributed software network that fix critical flaws are:
1. Uniform data structure (objects)
2. Physical provision of objects by host
3. Logical provision of objects by application
4. Ownership of objects by user
5. Applications can be distributed over multiple hosts
6. Hosts can be deployed by any network provider
7. Applications can create sub-hosts, that can be deployed independently
8. Host IDs are also application IDs
9. Hosts can be moved from one provider to another
10. Users have home hosts, which replicate essential user information
11. The system maintains sessions
12. The system provides login services
13. The system provides secure messaging

Some of these fixes are present in the present inventor's above-mentioned previous patent, Networked computing using objects, U.S. Pat. No. 7,752,335 B2. Additions herein include the introduction of the concepts of “application” and “sub-host” and the integration of those concepts into aspects of the distributed network architecture of the previous patent.

The concept of an application makes it possible to restructure the architecture of the network around the creation, distribution, and management of applications, the natural unit of software development and use. The concept of a sub-host makes it possible for application developers to create units of distribution, enabling the deployment (and re-deployment) of these units at a later stage, and to give users control over the distribution of their data.

In this disclosure, the terms, “host”, “server”, “hosting server” and “provider” are used. The terms “server” and “hosting server” refer to physical networked computing devices or groups of devices including server farms, or the software that enables them to be networked, and the term “provider” refers to an entity that provides servers and is identified on the internet by an IP address or URL. The terms may be interchangeable.

The term “host” refers to an abstract notion that does not change when the physical location of the host is changed. The host ID is mapped to the network identification of the provider. On the Internet the host ID is mapped to a URL or IP address. The mapping may be changed, so that objects may be moved transparently from one physical server to another.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

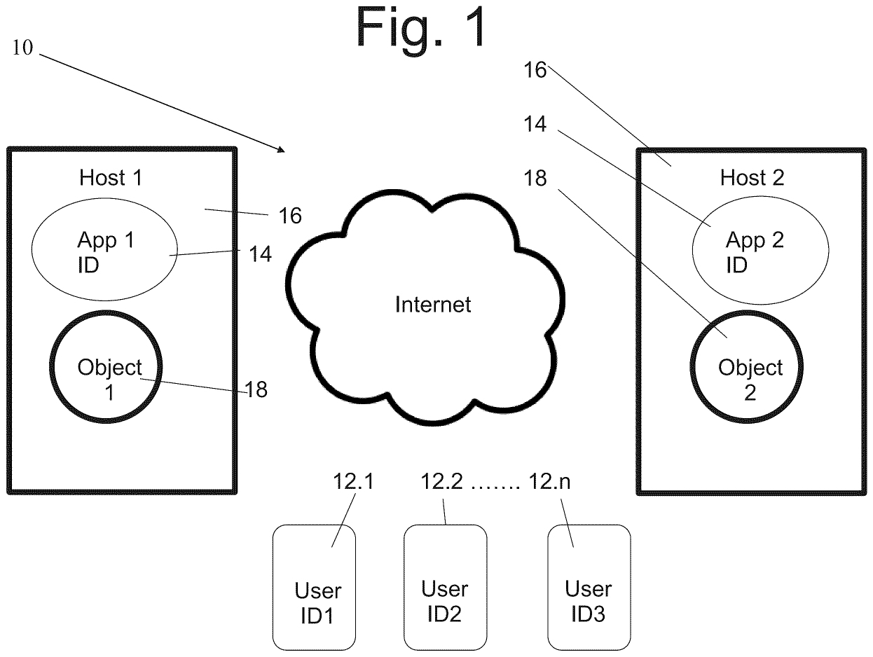

Referring now to the drawings, FIG. 1 illustrates a networked computing system 10 for facilitating distributed software and allowing independent access by a remote entity to the software via data.

The computing system is made up of multiple remote terminal devices 12.1, 12.2, 12.3 . . . Each remote terminal device may be any kind of networked computing device including desktops, laptops, mobile telephones etc. Each remote terminal device has one or more user identities and may be associated with one or more users. Applications 14 are distributed around the network on hosts 16, and the hosts are on servers. The applications may be any kind of application and allow for manipulating data of different kinds. Each application has an application identity and each host 16 has a host identity.

The hosts may have data for remote access and manipulation, and the data is stored in software objects 18 hosted thereon. The objects 18 may be created or at least manipulated by the applications at the behest of end users and thus the object is associated both with a given application and a given user. For that matter the object is also associated with a given host. The objects thus include their enablement data and content, as well as the relevant identities, thus a unique host identity indicating the host or a provider of the object, a user identity of a respective user, an application identity of the application that implements the functionality of the object, and a unique object identity. Thus each object contains within in it a unique identity as an object and also is associated with a specific host, a specific application and a specific user.

The host and user identities may enable end users at their respective remote terminals 12.1 . . . to access their own enablement data and content of a hosted software object simultaneously. However the user identity part ensures that different parties are actually working on different software objects. That is to say the respective host and user identity arrangements ensure that manipulations of the software object by one user is independent of manipulation of the apparently same remote object by any other remote entity. Furthermore, each object and corresponding set of identities may be transferred to another hosting server by changing the mapping between the object's host and provider, and continue functioning as before for security reasons, cost or any other reason. Throughout the process the user identity and the application identity are retained, allowing the end user to retain a relationship with the software object and use suitable applications wherever they may be found. That is to say, the application identity within the object enables the object to find a suitable application for manipulation irrespective of where the object and the application for manipulation are hosted. Likewise the user is free to find applications from different providers and the object will still work. The same application may in examples be found on many providers.

Thus the end user has control of the data and can freely find applications to manipulate it. There is no requirement that the object and application manipulating it are located with the same provider.

In embodiments, the hosts may be subdivided. For example different user identities may be given their own subdivisions, or different applications may have their own subdivisions. In some cases application subdivisions may be further subdivided for different users, or user subdivisions may be divided for different applications.

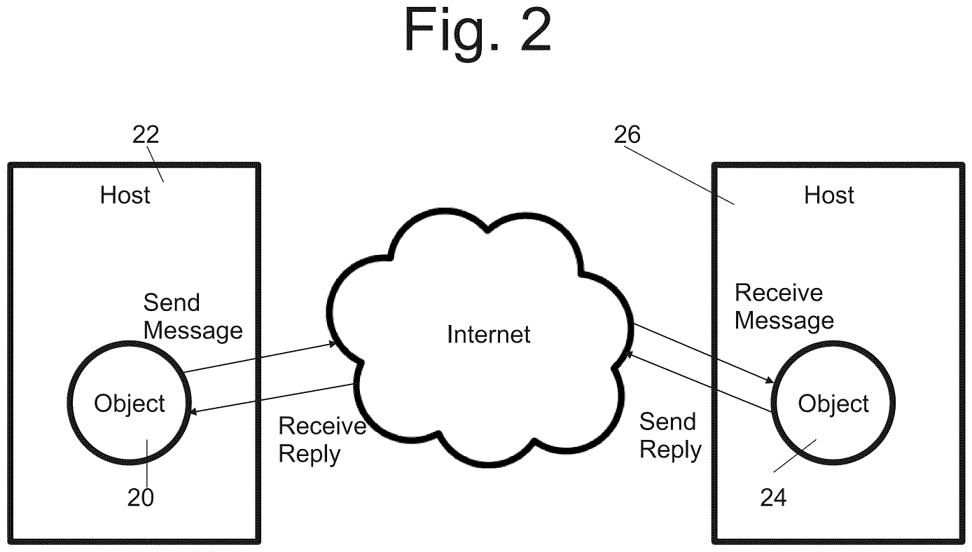

In the object, the host identity, the application identity, the user identity and the object identity are combined to provide a unique object identification. Hence unique addressing is possible and the unique object identification allows for communication with other objects. As shown in FIG. 2, object 20 on host 22 sends a message to object 24 on host 26. The object 24 sends back a reply to object 20. Generally, messages between objects will be described by a service, as will be discussed in greater detail below.

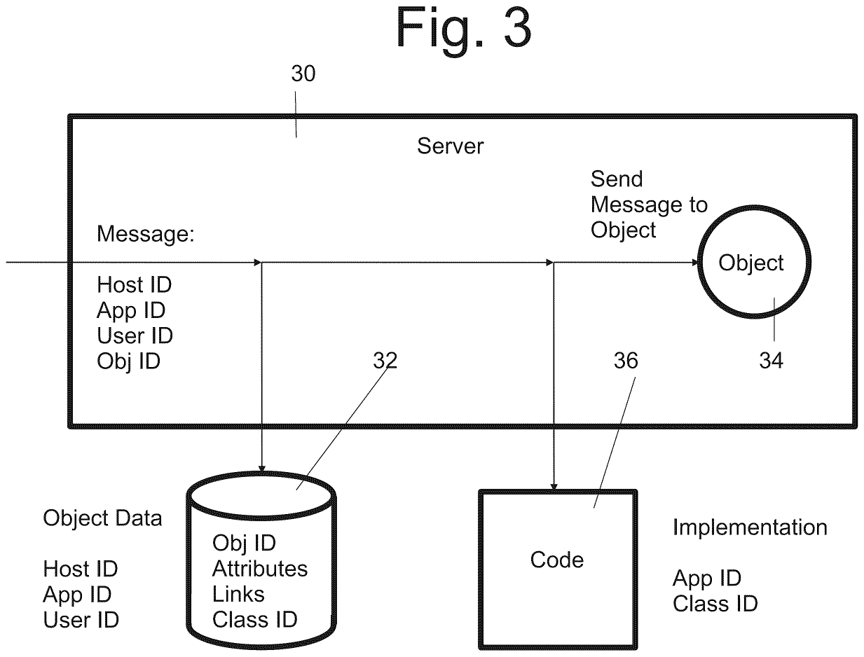

Reference is now made to FIG. 3, which is a simplified diagram illustrating how a host may be set up on a server 30 and use a database 32 for storage of the object data. Identities of the object 34 allow a message to be delivered to the object 34. said database configured to store corresponding data for each object. Database 32 may include at least attributes, links and class identities for each object, as will be discussed in greater detail below. The code implementation 36 of the object may be stored separately from the object data.

The database 32 may be a networked database storing the different host identities, application identities and user identities for many objects.

The server 30 may receive a message for object 34, and is responsible for delivering the message to the correct object based on the identities. However for security of the system it may only pass on the message to the respective object if the server is able to authenticate the message. Authentication may involve verifying both the sending object and the user ithat sent the message. For example, the authenticating process may check with a certifying authority that has certified the sending application. The process may then require the sending application to verify the user indicated in the message.

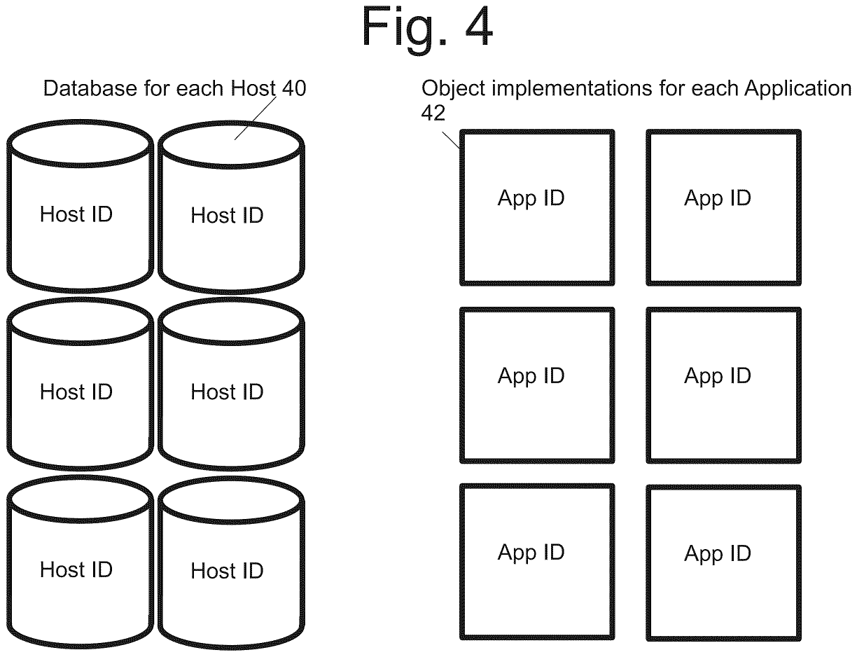

FIG. 4 illustrates provider architecture according to embodiments of the present invention. A provider has a database 40 for each host, and has object implementations 42 for each application. Users may have many hosts, of many different applications, which are located on a given provider. Providers may have the implementations of each application that they support installed on their servers.

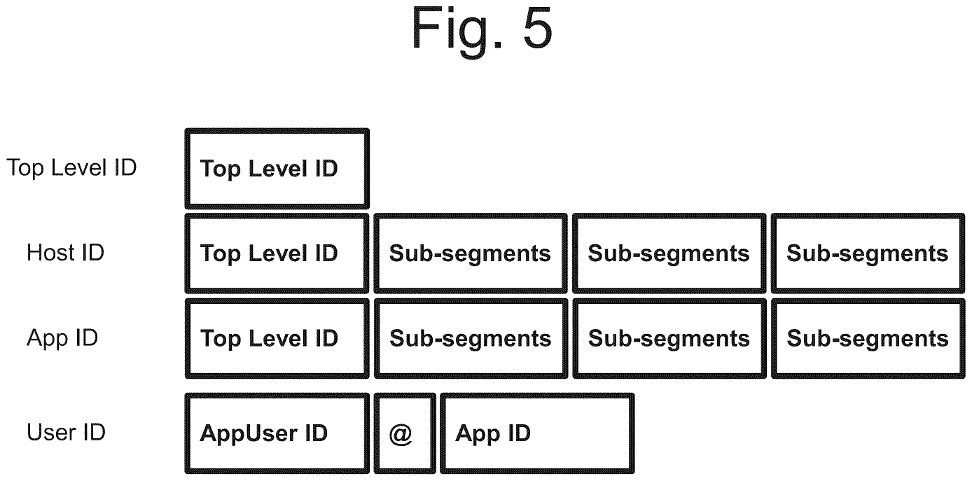

Reference is now made to FIG. 5, which is a simplified diagram illustrating schematically an embodiment of the identification system. An application is distributed over many hosts in the network, each host identified by its host ID, and a certificate authority for the application identified by the host has an ID which is equal to the application ID The host identification comprises one or more segments, the first being a top level identification. The top level identification may be allocated centrally over the network in question and be unique over that network. Host IDs and Application IDs may also consist of a top level ID and sub-segments. Sub-segments may be provided to divide the host as discussed above. The user ID is unique within an application, and may be combined with the application ID, so that the user ID identifies the user uniquely within the network.

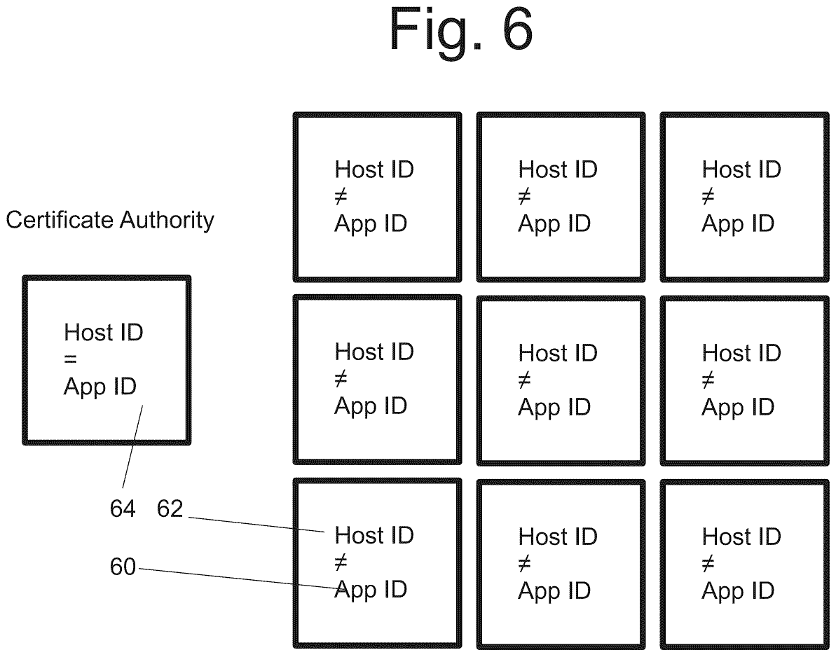

Reference is now made to FIG. 6. Network servers provide for hosts of objects, and for applications. Applications 60 may create many hosts 62, located on many providers and owned by many different users. Any particular provider may select the applications or kinds of applications that it hosts, and a certifying authority 64 may authenticate the applications. The certificate authority of the application is located on a particular host, in this case it is located on that host where the host ID equals the application ID.

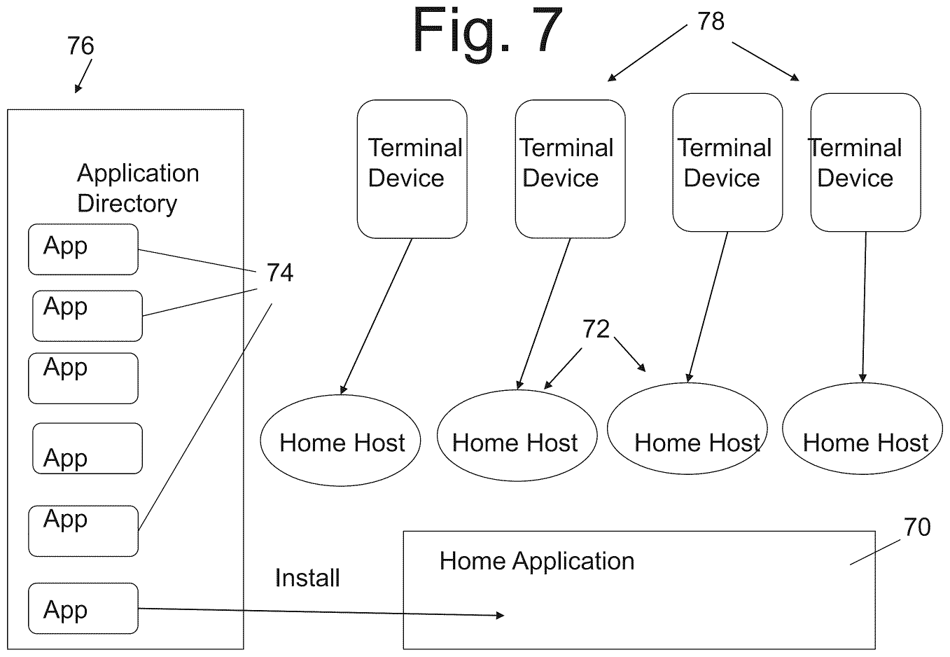

Reference is now made to FIG. 7, which is a simplified diagram illustrating the use of a home application 70, and home hosts 72, and how applications 74 are discovered in an application directory 76 and installed per end user—via terminal devices 78—in a home application 70. The various providers that provide hosts may provide a home application 70. The home application implements home hosts 72 through which individual users access the home application via their terminal devices 78. The home host holds centralized information for the respective user.

The application directory 76 registers applications for distribution. Users may search the application directory 76 for applications of interest, and then, as an application is selected, it is installed on the home application 70 through which they have access from a home host 72.

As shown in FIG. 7, applications and hosts are installable per user. A user does not see an application installed for a different user, even if it is installed on the same home application, since the object and user identities are different. Accordingly a user is able to recognize an object created by the applications and hosts that user has installed, and may reject an object created by an identical application or host from elsewhere. As explained earlier, messages may be received from other objects, however the messages may have to be verified before being accepted.

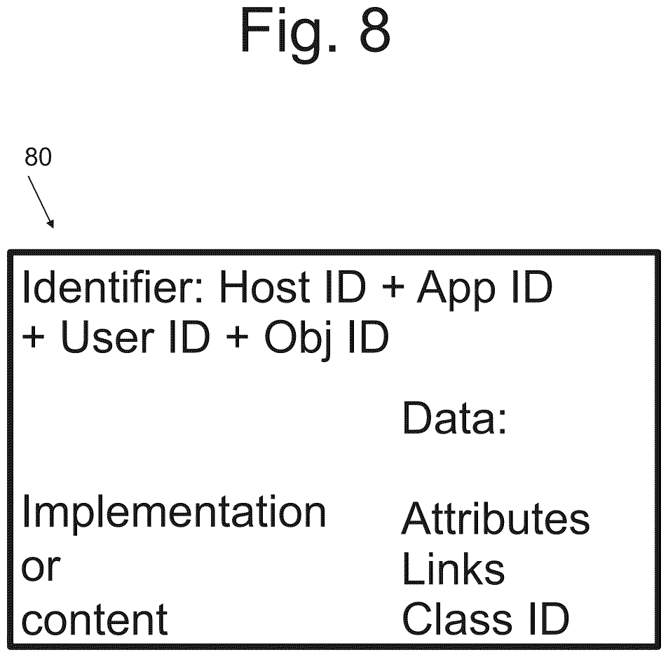

Reference is now made to FIG. 8, which is a simplified diagram illustrating a hosted software object 80 according to embodiments of the present invention. The object holds enablement data, content and its identifier. The identifier is made up of a unique host identity which indicates a host or a provider of the object, a user identity indicating a particular end user, an application identity indicating the application that the object was created with and/or may be used with, and unique object identity. In addition, the object may contain an implementation or content. The host identity, the application identity, the user identity and the object identity may combine to provide a unique object identification, meaning it is unique over the network. The unique object identification may thus be used for unambiguous communication with other objects over the same network.

The network may be built on top of the standard browser-server web technology, on the server side. When built on the World Wide Web, it is an extension to a web server.

Objects are the most basic unit of the network. The term “object” in this network refers only to the external description of the object, not its implementation. Objects can be implemented in any language, in any operating system. That does not mean of course that the object does not have an implementation.

Objects can send messages to other objects based on their IDs, and receive messages from other objects. Objects can also have links to other objects. There is a standard format for all messages, such as JSON or XML that makes all objects interoperable, whether they are on the same server, or a different server. From the point of view of the object, there is no difference between interacting with an object locally or remotely, so that the objects can be located anywhere on the network.

As discussed above, every object is identified by a four-part ID. IDs can be implemented as character stings, numbers, or any other identifier. The parts of the ID are as follows:
1. Host ID
2. Application ID
3. User ID
4. Object ID

Host ID: The host ID identifies the physical location of the host. It is mapped to the network identification of the host. On the internet, it is mapped to a URL or IP address. The mapping can be changed, so that objects can be moved from one physical server to another. The host ID is segmented. One segment of the host ID is unique system-wide, and the owner of the host ID can add segments. We will call the unique segment of a host ID a “top-level ID”. Since the top-level ID of the host ID is unique network-wide, the whole host ID is also unique network-wide. Each host ID (including all segments) can be mapped to a different URL, so that applications can define modules of distribution, which can be moved from one physical server to another.

Application ID: The application ID identifies the application that the object is associated with. Every object is created by a specific application, which also provides the functionality of that object. The application ID of an object's four-part ID is the ID of the application that created it, provides its functionality, and can modify it. Having an application ID as part of an object's ID means that applications can create objects independently of any other application. Every application ID can be used as a host ID. That is, every application has a unique ID that can function as either an application ID or a host ID. Put the other way around, every host has the option of supporting one application.

User ID: The user ID identifies the owner of the object. Every object has an owner. The owner can be a person, or an abstraction of some kind, such as a company or a role in a company. The user ID of an object identifies the user that controls the access and use of an object. Every access and use of an object is by a user that is identified by a user ID. When an object gets a message, the message includes the user ID of the user who sent the message. This way, the owner of the object has the ability to know which user is accessing or using the object, and control the functionality that each user is able to access.

Any application can allocate user IDs, the application ID is incorporated into the user ID to ensure that user IDs are unique network-wide.

Object ID: The object ID is simply an ID that makes each four-part ID unique. While host IDs, application IDs, and user IDs are unique network-wide, the object ID is unique only for a given combination of host ID, application ID, and user ID. Object IDs are necessary because a particular user can have more than one object from a particular application, on a particular host—and each object must be identified by a unique ID.

Database: Objects can be stored in any kind of database, relational or non-relational, or even directly in a file system. However, all databases must be able to store the same kinds of data for each object, including the following:
1. Attributes
2. Links
3. Class ID

Objects are stored in databases per-host, with one logical database for each host. Many logical databases may be stored together in a single physical database, but it must be possible to add, delete, and move logical databases from one physical database to another, independently of other logical databases.

Attributes: Attributes are the way that data is stored in an object. Each attribute consists of a name and a value.

Links: Links store the four-part-ID of the object that they link to, and may store additional information about the link, such as the link type, the application that created the link, the service that defined the link, the purpose of the link, a sequence number for ordering the links, and a value associated with the link, that can be used for purposes defined by the application.

Class ID: Class IDs identify the software that implements the object. The implementation can be in any language. One example would be to map class IDs to Java objects. Class IDs are per-application, and are unique in the context of a particular application, so you need a combination of application ID and class ID to get a unique ID that fully identifies implementations.

Server: When built on the World Wide Web, distributed software network servers are extensions of web servers. It is also possible to build servers directly on top of the internet, or another network. When a server gets a message for an object, it may authenticate the message with the sender application's certificate authority e.g. the message must come from a real object, that belongs to a real user, that is recognized by the sender application. If it is authenticated, the server may pass the message to the software that implements that object, according to the object's class ID.

Top-level IDs: The unique segment of host IDs and application IDs are top-level IDs. They are allocated centrally, and guaranteed to be unique network-wide. Top-level IDs can be the first segment of an ID, the last segment of an ID, or any other segment, as long as the unique segment of all IDs is consistent throughout the network. The allocation of top-level IDs may be the only aspect of the distributed software network architecture that is centralized.

The role of top-level IDs in the distributed software network architecture is similar to that of top-level domains in the internet architecture. The owner of a top-level ID can create new IDs that have the top-level ID as the unique segment. These new IDs can be used either as host IDs, to indicate the physical location of an object, or as application IDs, to indicate the application that supports the functionality of the object. Top-level IDs fulfill one of the fundamental architectural goals of the distributed software network: To give applications the ability to work independently of any central authority.

Login Application: In order to use the distributed software network, a user has to be logged in. Login services may be provided by trusted hosts running the Login application. Since applications are distributed, this means that login services can be provided in a decentralized manner, with each trusted provider working independently. The OAuth standard may be used for this purpose.

Message Security: Since applications are distributed, and messages may come from objects that are hosted anywhere, it is essential to have a secure messaging system, to ensure that a message really does come from the object that it appears to come from. Each application is responsible for the security of its own messages. The certificate authority for each application is located at a predefined host, for example the host that is identified by the top-level ID of the application. When a server receives a message, it checks with the certificate authority of the application that the message claims to be from, to determine if it is a real message, and if it is really from the object that it claims to be from.

Sessions: Servers keep track of sessions. Sessions can be initiated externally, by a user, or internally, by an object. When an object sends a message without initiating a new session, the current session is propagated, and sent along with the message.

Services: Services are abstract classes. Services define the messages that an object can receive, without implementing them, and are a way to publicize the definition of objects. For example, if there is a book service, any object that implements it is a book object, and applications that work with books can look for book objects, and use them. Implementations of network servers may provide utilities for verifying that messages that they receive are correct, according to the services that the recipient object implements. Services support multiple inheritance. Classes may support only one service, which means that all inheritance takes place within services, rather than within classes.

Providers: Providers are hosts that provide physical support for hosts. Every host has a provider, which may be itself. Providers may be supported by an application that provides hosting utilities. Providers may undergo verification in addition to the verification that is required to obtain a top-level ID.

The Provider's point of view: In order to be a provider that hosts applications, distributed software network sites must install software that implements the functionality of the network server. Once this is done, the site can support any number of hosts, limited only by the physical constraints of the site. In order to support applications, providers must install the software that implements the application's objects. This software is provided by the application developer or distributor. The distribution and installation of application software is the responsibility of the provider and the application developer. Network providers are not required to support all applications, they only support the specific applications that they choose to support. Applications may provide directories of providers that support them.

The User's point of view: Users may have objects on any number of hosts. For each host, objects are stored in a database that can easily be moved from one distributed software network provider to another. There is no problem with one provider supporting multiple hosts that belong to the same user and the same application-the different hosts remain logically independent, even though they have the same provider, and are physically located on the same network site, they can be redeployed independently.

The Application's point of view: Applications create hosts that may be deployed on many different providers, by many different users. There is always a central host, where the certificate authority is located, and where external users and applications can contact the application when they know nothing else about it. This may be the host whose host ID is the same as the application ID. Applications are made of objects, that are identified by their four-part IDs, can receive messages from other objects, and have functionality provided by the application. Users can redeploy their hosts at any time, without changing the functionality of the application.

Home Application: Every user has one or more Home hosts, that are implemented by the Home application. All providers are capable of hosting the Home application if they choose to do so. Home hosts store centralized information for users, such as login and installation information. They also provide key functionality such as application installation. Home hosts are redundant, so that there is no single point of failure. All of a user's Home hosts contain the same information, so that if one is lost, any of the others can be used instead. A change to the home information in one host updates the other home hosts of the user.

Application Directory: The Application Directory is a place where applications can be registered, giving users the ability to find them. It is the equivalent of the Apple App Store or Google Play Store for the distributed software network. However, instead of installing applications on your phone, it installs applications in your Home Application.

Installation: One possible problem is that a hostile entity could potentially create objects that falsely belong to a user. Users need to be able to differentiate between objects that really belong to them, and objects that falsely claim to belong to them. One way that users do this is by “installing” applications. Installing an application does not entail physical installation, since physical installation is done by providers. Rather, it means that the user recognizes the application as one that can create objects for it. Any object not created by an installed application is not recognized as an object belonging to the user.

Similarly, users need to install hosts. Any object not located on an installed host is not recognized as belonging to the user. A user's objects may only be located on installed hosts.

Installation of applications and hosts is done by the Home application, and the Home application keeps track of which applications and hosts are installed for each user.

Developing applications: Implementations of network servers may provide a framework for developing applications that work with the distributed software network. This includes defining and storing objects, services, and classes, and includes implementing the functionality of objects, sending messages, keeping track of sessions, defining access rights, interfacing with the user interface, and maintaining security.

Distributing and Deploying applications: Before an application can be distributed, a top-level ID must be acquired for the application. Acquiring a top-level ID, which can also function as a host ID, is the only thing that is centralized in the distributed software network. All other things can be done without centralized control. Acquiring a top-level ID may involve verification of a real person or organization that is responsible for the application, and other information that is critical for ensuring responsibility. Once a top-level ID is acquired, the application developer can set up a network server to host the application, or set up the application on an existing provider, with the cooperation of that provider. Application developers can let users work directly on the application's original provider, or create sub-hosts for users, which users can set up on the provider of their choice. In order for a provider to support a particular application, it may install the implementations of the application's classes. Distribution of implementation code may be by any means that the developer chooses.

User Experience: To use the network, a user must first log in. To log in, users go to the user interface of the provider of any of their Home hosts, and log in. If the network is built on the World Wide Web, the user interface will likely be a web page. Once users are logged in, they can go to any other application on the network, and the application that they are using will recognize them. They can go to one of their own applications, or they can go to another user's application, if the application permits it. The scenarios are endless, because all applications can interoperate, if the applications involved permit it. A user can work on another user's application, or a user can access data belonging to another user, and work with it. For example, if the other application is a bookstore, a user might take a book from a bookstore, and use that book in its own spreadsheet. In this example, the book might be an object that belongs to the bookstore, or even a third party, and the spreadsheet is an object that belongs to the user.

If the distributed software network is built on top of the World Wide Web, it will look, superficially very much like the World Wide Web today, except that many of the web pages are actually private web pages owned by the user, or owned by another user, and not accessible to everyone. The user will also be able to go to one of the user's Home pages, and see “under the hood”—that is, see where all its applications and data are located, and to examine it. The user will be able to inspect and manipulate the data directly, and move the data to other providers. The Home application may provide additional information, such as which other objects, applications, or users accessed the data, when, in which order, etc. Basically, users will be able to do anything they want with their data, because it belongs to them.

Example, Word Processor: The goal of a word processor using the distributed software network is to provide all the functionality of a PC-based word-processor, but online, and to enable the user to truly own their own documents, and store them on any provider that supports document functionality.

Document Service: The developer defines a Document Service, which standardizes the messages that a document understands, such as for adding and deleting text. This makes it possible for many different applications to implement Document objects that can work with the word processing application.

Host-naming scheme: The developer wants to support multiple users, each of which can store documents in multiple locations on the network. The word-processor application may also need to distribute its own objects over multiple hosts, so it creates one sub-host for its users, under which it employs the user ID to separate the hosts of each user, under which it enables each user to create sub-hosts. An exemplary resulting host naming scheme for the application is as follows: word-processor.user.<userID>.<user-created host names>

Implementations: Finally, the developer may write the code that implements the functionality of document objects, in addition to any other objects that the application requires.

Installation: After the application is developed, it may be registered with the Application Directory. Providers may install the application software, and begin deploying word-processor hosts. The application developer may be the first application provider. Users can then install the word-processor application, and begin creating documents.

Example, Microblogging: The goal of microblogging is to create an environment in which users can post short text messages that other users can read. Currently, there are several popular microblogging systems, which are unitary applications on the World Wide Web. In other words, with current microblogging systems, one web site owns all of the blog posts. In the distributed software network, users will own their own blog posts, and be able to locate them on any provider they want, as long as the provider supports the microblogging application, but will be able to view the blog posts of other users no matter where they are located, in the same way that they can be viewed in unitary microblogging systems.

The Microblogging application may define a Post Service similar to the Document Service of the Word Processor application, and host-naming scheme similar to the host-naming scheme of the Word Processor application.

The Microblogging application may consist of two parts: posting and viewing. Posting is straightforward, the application simply saves the post object with the provider that the user chooses. Viewing is more complex. The viewing part of the application has to gather all posts that the user wants to see, that are located on many different providers, and present them on the user's screen. To do this, the user saves, in one place, a list of other users that this user follows. The application then uses this list to get the posts from the places where they are stored, and present them to the user.

In a microblogging application, most users may spend most of their time not interacting with their own objects, but interacting with the objects of other users. In other words, most of the time, users are not posting, but viewing other users' posts. This is an example of an application that is not merely distributed in the sense that it is working in many places at once simultaneously, but, in addition, the distributed parts work together to provide a user experience that is greater than the sum of the parts.

Example, Online BPM: The goal of BPM (business process management) is to automate the various steps of a business process. Many BPM processes are difficult to implement online because of the business requirements of the customer. It might also be impossible for practical or legal reasons to store data on third-party sites. Currently, the alternative to an online application is a traditional in-house solution. However the in-house solution still requires back-up. Safety from fire requires the backup to be elsewhere, and thus any organization not having multiple sites has to rely on external servers at least for backup. In the distributed software network according to the present embodiments, another option is available. Customers may install applications on their own servers, or on virtual servers provided by web hosts, that are under their full control. They may additionally install their own security systems, and, of course, they may have full ownership and control of the data, while being a fully online solution.

In this document, the terms “comprises”, “comprising”, “includes”, “including”, “having” and their conjugates mean “including but not limited to”.

The term “consisting of” means “including and limited to”.

As used herein, the singular form “a”, “an” and “the” include plural references unless the context clearly dictates otherwise

It is appreciated that certain features of the invention, which are, for clarity, described in the context of separate embodiments, may also be provided in combination in a single embodiment and the present description is to be construed as if such embodiments are explicitly set forth herein. Conversely, various features of the invention, which are, for brevity, described in the context of a single embodiment, may also be provided separately or in any suitable subcombination or may be suitable as a modification for any other described embodiment of the invention and the present description is to be construed as if such separate embodiments, subcombinations and modified embodiments are explicitly set forth herein. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

1. A networked computing system for facilitating distributed software and allowing independent access by a remote entity to the software via data, said system comprising:
a plurality of remote terminal devices, each remote terminal device being associated with at least one user identity and a corresponding user;
a plurality of applications for manipulating data, each application being associated with an application identity;
a plurality of hosts, said plurality of hosts operative for storing data, said data for remote access and manipulation, the data being stored in software objects associated with respective applications, the software objects being hosted on hosts, said hosts each having a unique host identity, said hosted software objects respectively comprising:
enablement data,
a host identity of a host associated with said object,
a user identity of a user associated with said object,
an application identity of an application associated with said object, and
a unique object identity.

2. The networked computer system of claim 1, wherein said host and said application and said user identity arrangements, being contained within said hosted software objects and comprising said respective unique identities, enable a plurality of entities at respective remote terminals to access said enablement data, said respective host and application and user identity arrangements being preserved with said access such that manipulations of said software object by any one of said remote entities is independent of manipulation of said remote object by any other remote entity.

3. The networked computer system of claim 1, wherein each respective host identity arrangement is transferable with correspondingly independently manipulated data to another one of said hosting servers for a second manipulation with said software object, said second manipulation preserving said host identity, application identity, and user identity, thereby allowing said respective remote entity to retain a relationship with said software object after manipulation thereof through said first software object.

4. The networked computer system of claim 1, wherein said application identity arrangement, being contained within said software object, enables said object to find said application for manipulation irrespective of where said object and said application for manipulation thereof are hosted.

5. The networked computer system of claim 1, wherein said hosting servers are configured to be subdivided based on one member of the group consisting of application and respective user identities.

6. The networked computer system of claim 1, wherein said host identity, said application identity, said user identity and said object identity are combined to provide a unique object identification, said unique object identification being usable for communication with other objects.

7. The networked computer system of claim 1, comprising a database for storage of respective objects, said database configured to store corresponding data for each object.

8. The networked computer system of claim 7, wherein said corresponding data comprises at least one member of the group consisting of attributes, links and class identities for each object.

9. The networked computer system of claim 7, wherein said database is a networked database storing at least one member of the group consisting of a respective host identity, a respective application identity and a respective user identity for a plurality of said objects.

10. The networked computer system of claim 1, further comprising a server, the server configured to pass a message to an object based on an ID of the object contained in the message.

11. The networked computer system of claim 10, wherein said server is configured to receive a message for an object and only to pass on the message to the respective object if the server is able to authenticate the message.

12. The networked computer system of claim 10, wherein the authenticating is to verify both the sending object and the remote user.

13. The networked computer system of claim 11, wherein said authenticating uses a certifying authority of a sending application and uses said sending application to verify said remote user.

14. The networked computer system of claim 1, wherein said host identification comprises at least two segments, one of said at least two segments being allocated centrally over said networked computer system and being networkwise unique.

15. The networked computer system of claim 1, comprising network servers configured to provide hosts for said objects, said networked servers further being configured to support selected ones of said applications.

16. The networked computer system of claim 1, comprising a home application and home hosts implemented by said home application, each user having at least one home host, the home host comprising centralized information for the respective user.

17. The networked computer system of claim 1, further comprising an application directory for registering and distributing applications, the application directory being configured to install requested applications in a home application accessible via a respective user's home host.

18. The networked computer system of claim 1, wherein applications and hosts are installable per user so that a user is able to recognize an object created by an application or host installed by said user and reject an object created by an identical application or host not installed by said user.

19. A hosted software object comprising:
enablement data:
a host identity arrangement holding a respective unique host identity indicating one of said plurality of hosting servers or a provider of said object;
a user identity arrangement holding a respective user identity,
an application identity arrangement holding a respective application identity; and
an object identity arrangement holding a unique object identity.

20. The hosted software object of claim 19, wherein said host identity, said application identity, said user identity and said object identity are combined to provide a unique object identification, said unique object identification being usable for communication with other objects.

21. A network server, configured to host a software object, the hosted software object comprising:
enablement data:
a host identity arrangement holding a respective unique host identity indicating one of said plurality of hosting servers or a provider of said object;
a user identity arrangement holding a respective user identity,
an application identity arrangement holding a respective application identity; and
an object identity arrangement holding a unique object identity.
